(19) United States
(12) Patent Application Publication
(10) Pub. No.: US 2005/0119594 A1
(43) Pub. Date: Jun. 2, 2005

(54) Vacuum massage device comprising the affusion of water or any other suitable liquid

(76) Inventors: Elie Piana, La Valette (FR); Christian Le Stum, Massy (FR)

Correspondence Address: GREENBLUM & BERNSTEIN, P.L.C., 1950 ROLAND CLARKE PLACE, RESTON, VA, 20191, US

(21) Appl. No.: 10/510,235

(22) PCT Filed: Mar. 4, 2003
(86) PCT No.: PCT/FR03/00683

(30) Foreign Application Priority Data
Mar. 4, 2002 (FR) 02/02719

(51) Int. Cl. A61H 7/00; A61H 9/00; A61H 23/02; A61H 23/04

(52) U.S. Cl. 601/7; 601/17; 601/19; 601/155; 601/169

(57) ABSTRACT

Vacuum massage device under affusion of water or any other suitable liquid having an interchangeable massage head connected to an upper body by contacts responsible for inflow of a supplied pressurized fluid and the suction and inflow of an active product contained in a receptacle on bearing rollers. The pressurized fluid is sent to the receptacle, thereby enabling the active liquid to be injected under pressure onto the rollers. The fluid is distributed through channels which open out onto the periphery of the head and into the suction chamber. Patient lies on a special mattress having a channel to drain any liquid not absorbed by the vacuum. This Abstract is not intended to define the invention disclosed in the specification, nor intended to limit the scope of the invention in any way.

The present invention relates to a vacuum massage device under affusion of water or any other suitable liquid.

It relates to the industrial and commercial field of manufacture and distribution of devices and accessories generally intended for medical or paramedical offices, thermal centers, thalassotherapy institutes and hospital units offering massages.

Originally, massage, a term derived from the Arabic word “mass” which means to feel by touch, involved pressing, kneading various parts of the body with the hands to make muscles flexible.

Nowadays, massage is more frequently performed by means of devices and is used in a large number of fields such as in plastic or reconstructive aesthetics, traumatology, rheumatology, phlebology, sport kinesiotherapy, scars and burns treatment, circulatory troubles, lymphatic drainage and tissues tightening.

There are several types of massages depending upon the treatments to be performed. The type related to the device according to the invention is the “palpating and rolling massage” under affusion of water. It is used in particular in the treatment of cutaneous, cellulitic and dermalgic zones for example, and is carried out by performing on the patient a continuous action during which the masseur simultaneously not only pinches locally so as to create a cutaneous fold but also gradually moves the pinched zone in a liquid environment.

A “palpating and rolling massage” is currently performed with the help of devices comprising a movable head adapted to be moved on the skin and connected by a flexible conduit to an air suction device capable of creating a vacuum at the level of the epiderm when the head is applied against the body of the patient.

There are heads with parallel cylindrical rollers, movable in rotation and possibly in translation, heads with peripheral balls, heads with a slit, and finally, heads which do not make folds: the bells.

All of these suction heads and devices are used in a constant density environment, air. Leaks due to mechanical plays are constant and the suction is not subject to variations. Some devices and heads attempt to operate while completely submerged in water where the “environment” is also constant and, therefore, controllable.

Massage under affusion of water is mainly performed in thermal and thalassotherapy centers. The patient lies down on a table, and he is sprayed with fixed or movable small showers (“Vichy shower”). A massage by hand can be performed at the same time; the masseur wears a bathing suit and is sprayed copiously.

The device according to the present invention aims to provide a massage of the palpating and rolling type under affusion of water, the subject lying down on a pneumatic mattress specially made for this use. The four sides of the mattress are raised in order to protect the masseur from backwash. This mattress is positioned on an inclined massage table and a water drainage connected to the sewerage allows the unsucked liquid to be drained. The liquid sucked by the pump also flows into the drain.

On the annexed drawings provided as a non-limiting example of one of the embodiments of the invention:

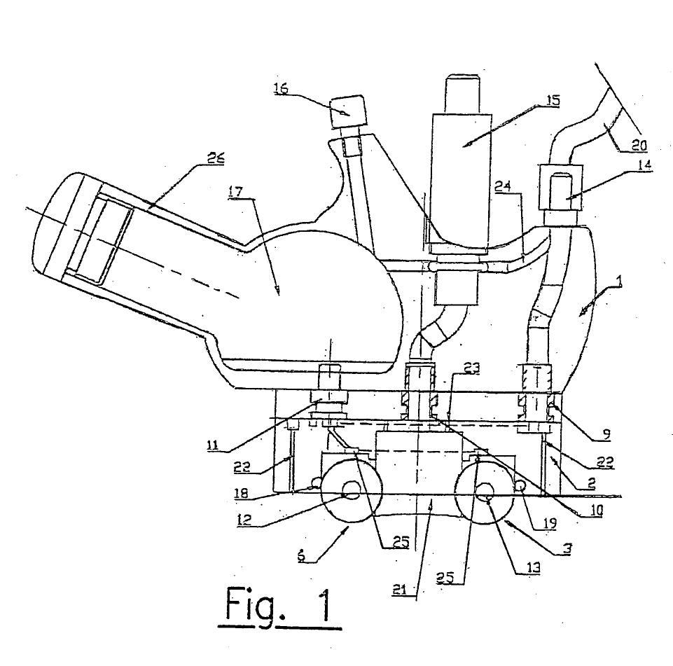

FIG. 1 shows a cross-section of the device according to the invention in its entirety,

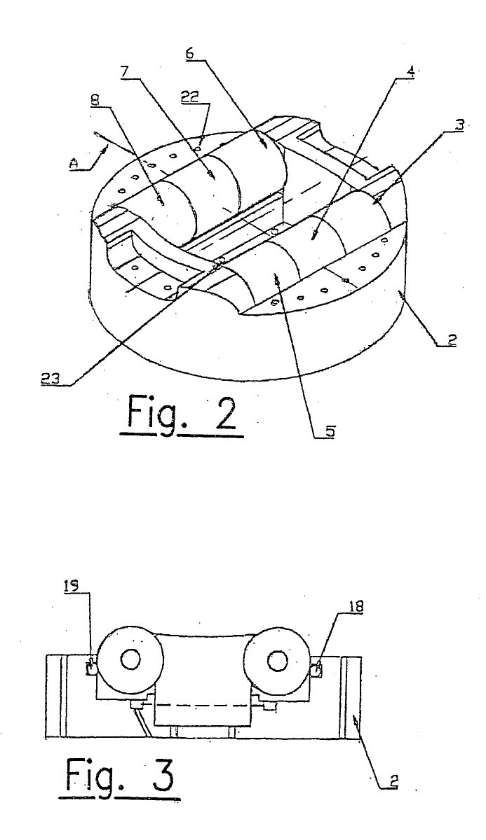

FIG. 2 shows the head, the rollers as well as the channels allowing the spraying,

FIG. 3 shows a vertical cross-section of the head along the arrow A of FIG. 2,

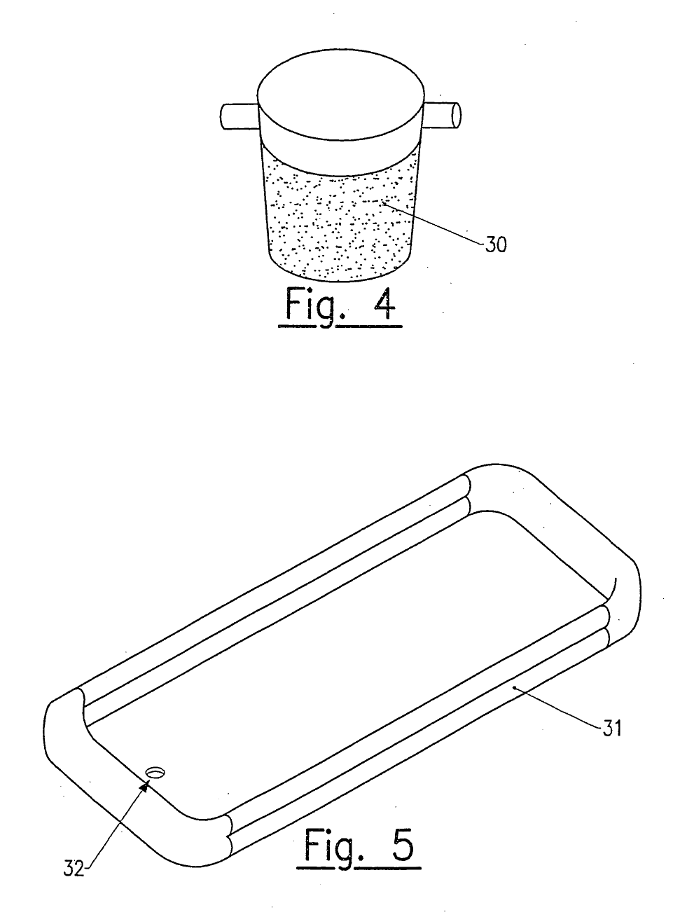

FIG. 4 shows a distributor of active salts that gets inserted in the liquid intake hose; and FIG. 5 shows the anti-backwash mattress in perspective.

The device, made of an upper body (1) on which an interchangeable massage head (2) is mounted allows to perform a spraying due to the intake of a pressurized fluid through a flexible hose (20) at the same time as a mechanical massage of the “palpating-rolling” type, the spray by a preferably hot fluid such as thermal water, sea water, etc . . . being incorporated in a massage head (2) which moves in all directions, due to a plurality of rollers (3,4,5,6,7,8) mounted on two parallel axles (12, 13). In addition, the thrust of the spray further facilitates the manual displacement of the massage head under affusion.

The imperviousness is achieved by a sealing ring (18) and (19), parallel to each group of rollers.

A handle receptacle (17, 26) located in the upper body (1) distributes a suitable active liquid, through an interchangeable nozzle (1 1) at the level of the rollers (3,4,5,6,7,8) and, as soon as the vacuum increases, the liquid arrives by suction. Depending on the length of the threading of the connector (14), the spraying liquid can or cannot communicate with the top of the receptacle and inject the active liquid under pressure.

The upper body (1) is immobilized and centered on the active head (2) by means of three independent contacts (9, 10, 1 1) which fulfill the following functions:
intake of the pressurized shower fluid
vacuum channel
intake of the active liquid

One can easily uncouple these two pieces at any moment in order to be able to clean the active head (2) which comes in contact with the patient or to replace it with another identical, possibly smaller or larger head, the upper body (1) remaining the same.

Due to the present invention and its combinations, shower, active liquid, vacuum, the so-called “palpating-rolling” massage under affusion of water, also has the advantage of transmineralization, tissues softening, vasodilatation due to hyperemia and the benefits of the active liquid.

According to a preferred embodiment of the invention, the device is characterized by the connection of the massage head (2) and the upper body (1) by means of 3 contacts (9, 10, 11), respectively ensuring the intake of the pressurized fluid, the suction, and the intake of the active product on the bearing rollers (3,4,5,6,7,8) that can be of a cylindrical or ovoid shape, making it possible to move the head in all directions. In an alternative embodiment, these rollers can be replaced either by smooth or grooved rollers or by a fixed inlet-outlet forming the lower edge of the suction chamber and made of a sliding material (teflon). The rollers are mounted on 2 parallel axles (12) and (13), and rub laterally on an elastic joint (18) and (19), which ensures in part the imperviousness of the suction chamber. The massage head (2) is interchangeable by mere extraction with respect to the body (1) and can thus be replaced by another head. An alternative embodiment could be envisioned as a single unit (1 and 2 combined). The pressurized fluid will in general be thermal hot water from the sea or the city; in this latter case, an active salt dispenser (30) (FIG.4) is inserted serially in the liquid intake hose (20) connected (at 14) to the upper body (1), arrives and passes through the contact (9) in the lower head (2) or through small channels (22 and 23). It is diffused around the suction chamber and the rollers (3,4,5,6,7,8), as well as in the suction chamber (21), thus following any movement of the head.

The vertical thrust exerted on the head by this pressurized fluid (which presses on the proximal skin) reduces the effort needed to move the massage head stuck by the vacuum effect.

The pressurized fluid, under affusion, creates around the suction head a liquid ring which homogenizes the environment and regulates the flow/pressure variations due to the leakages from the mechanical plays. These leakages and the head movements let some air and fluid through, which are sucked in the chamber (21) connected to a pump by a connector (15). This sucked liquid massages the skin fold on its way; the sucked air provides great flexibility to the suction.

A handle receptacle (17, 26) is provided, which is part of the upper body (1) and contains an active liquid. This active liquid arrives on the rollers (3,4,5,6,7,8) or the rollers, inside the suction chamber by a groove (25) connected by a nozzle (11) and a channel to the receptacle.

It is possible to send the pressurized fluid in the receptacle (17), thus making a pressurized injection of the active liquid contained in this receptacle. The opening or closure of the channel (24) bringing the pressurized fluid in the receptacle (17) is ensured by the length of the threaded portion of the connector (14) which may or may not obstruct the channel.

The massage head is designed to function under affusion with a pneumatic mattress 31 which collects the streaming liquids and an evacuation opening (32) connected to a pipe that evacuates them to the sewerage (FIG. 5).

One can however use commercially available hard affusion tables. The head according to the invention can also function while immersed in a liquid but in this case, the 100% water suction no longer has any elasticity, it is jerky and can harm the patient. To overcome this, the receptacle 17 is left empty in this case and the suction chamber 21 is exposed to open air through a conduit normally provided with a stopper 16 which is then removed, which allows to obtain an air-water mixture. One can vary the quantity of sucked air by modifying the diameter of the hole of the nozzle contact (11). According to an alternative embodiment, the stopper will be replaced by a flexible tube connected to a pneumatic compressor which will insufflate air in the chamber 21, allowing a mixture with a higher air content and therefore a smoother suction.

1. Vacuum massage device under affusion of water or any other suitable liquid,
characterized in that it comprises a massage head provided with a suction chamber and designed to function under affusion, said massage head being connected to an upper body by means of three contacts ensuring the intake of a pressurized fluid, the suction and the intake of an active product respectively, rollers.

2. Device according to claim 1, characterized in that the massage head comprises bearing rollers having a cylindrical or ovoid shape, which makes it possible to move the head in all directions, said rollers being mounted on two parallel axles and each laterally rubbing against an elastic joint, so as to ensure the imperviousness of the suction chamber.

3. Device according to claim 1, characterized in that the massage head comprises two smooth or grooved rollers to allow its displacement.

4. Device according to claim 1, characterized in that the suction chamber comprises a lower edge forming a fixed inlet-outlet and made of a sliding material such as the “teflon so as to enable the head to move on the skin.

5. Device according to claim 2, characterized in that it is equipped with small channels injecting a fluid under pressure around the suction chamber and rollers, thus following any movement of the head, so as to reduce the effort necessary to produce to move the head massage stuck by the vacuum, and forming around the suction chamber a liquid ring that is able to homogenize the environment and to regulate the variations in flow/pressure due to the leakages from the mechanical plays.

6. Device according to claim 1, characterized in that the upper body and the massage head form a single unit.

7. Device according to claim 1, characterized in that the massage head is interchangeable by mere extraction with respect to the upper body and can thus be replaced by another head of a different size.

8. Device according to claim 1, characterized in that it is equipped with channels bringing part of the fluid under pressure in the suction chamber upon contact with the skin fold formed by the vacuum and spraying it.

9. Device according to claim 1, characterized in that an active salt dispenser is inserted serially in the pressurized liquid intake hose.

10. Device according to claim 1, characterized in that it is associated with a pneumatic mattress receiving the patient, having the four sides raised to avoid backwash and provided at one of its ends with a water outlet which is connected to the drain.

11. Device according to claim 1, characterized in that the upper body comprises an integrated handle receptacle containing an active liquid.

12. Device according to claim 2, characterized in that the active liquid arrives on the rollers or the rollers, inside the suction chamber, due to a groove connected to the nozzle contact and to the receptacle by a channel.

13. Device according to claim 11, characterized by a channel of the upper body allowing to send the pressurized fluid in the handle-receptacle, thus injecting under pressure the active liquid contained in the receptacle, the opening or closure of the channel bringing the pressurized fluid in said receptacle being ensured by the length of the threaded portion of the connector connecting the intake of the pressurized fluid to the upper body which may or may not obstruct the channel.

14. Device according to claim 1, characterized in that the pressurized fluid is hot water brought in by a flexible hose connected to the connector linking the intake of the pressurized fluid to the upper body.

15. Device according to claim 1, characterized in that to work with the massage head submerged in a liquid, the suction chamber comprises a conduit open to external air, normally provided with a stopper which is then removed, so as to obtain an air-water mixture.

16. Device according to claim 15, characterized in that the stopper can be replaced by a flexible tube connected to a pneumatic compressor which will insufflate air in the suction chamber so as to obtain a mixture with higher air content and therefore a smoother suction.
